(19) United States
(12) Patent Application Publication
(10) Pub. No.: US 2025/0349104 A1
(43) Pub. Date: Nov. 13, 2025

(54) METHOD FOR EVALUATING CLIMATE REGULATION VALUE OF VEGETATION, PRODUCT, MEDIUM, AND DEVICE

(71) Applicant: Institute of Ecological Conservation and Restoration, Chinese Academy of Forestry, Haidian District (CN)

(72) Inventors: Wenjing BO, Haidian District (CN); Jiazhe SUN, Haidian District (CN); Weiwei LIU, Haidian District (CN)

(21) Appl. No.: 19/023,743

(22) Filed: Jan. 16, 2025

(30) Foreign Application Priority Data
May 7, 2024 (CN) 202410553930.3

(51) Int. Cl. G06V 10/50; G06Q 50/06; G06V 10/75

(52) U.S. Cl. CPC G06V 10/50; G06Q 50/06; G06V 10/751

(57) ABSTRACT

Provided is a method for evaluating a climate regulation value of vegetation, a product, a medium, and a device. The method initially includes obtaining surface net radiations and latent heat fluxes of vegetation and bare land in a window staggered area by a window analysis method. A difference between sensible heat fluxes of the vegetation and the bare land in the window staggered area is calculated according to the surface net radiation and the latent heat fluxes of the vegetation and the bare land in the window staggered area. A climate regulation value of the vegetation is obtained by combining a replacement cost method of cooling by an air conditioner based on the difference between sensible heat fluxes of the vegetation and the bare land in the window staggered area.

### CROSS-REFERENCE TO RELATED APPLICATION

This patent application claims the benefit and priority of Chinese Patent Application No. 2024105539303 filed with the China National Intellectual Property Administration on May 7, 2024, the disclosure of which is incorporated by reference herein in its entirety as part of the present application.

### TECHNICAL FIELD

The present disclosure relates to the technical field of environmental protection, and in particular to a method for evaluating a climate regulation value of vegetation, a product, a medium, and a device.

### BACKGROUND

With the intensification of global climate warming, more and more attention has been paid to the climate regulation service of vegetation, but a method for evaluating the climate regulation value of the vegetation is still not perfect. The existing studies mostly use a temperature difference method or a transpiration method to evaluate the climate regulation value of the vegetation. The temperature difference method includes monitoring temperature reduction of the vegetation, and converting the cooling effect of the vegetation in a microclimate into absorbed heat through specific heat capacity of the air, and then converting the absorbed heat into power consumption of the air conditioner; where, in the microclimate, it is assumed that each square meter of vegetation affects a microclimate environment within bottom area of 10 square meters and a height of 100 meters. However, the assumed microclimate in this method has great uncertainty, especially in contiguous vegetation where the microclimates interact with each other, an estimation method of expanding the bottom area by 10 times will overestimate the climate regulation value of the vegetation. The transpiration method includes directly converting the transpiration of the vegetation into energy by vaporization heat, and then calculating the power consumption of the air conditioner. However, this method ignores the difference between surface net radiations of the forest and the bare land. The surface net radiation of the forest is higher than that of the bare land, which can bring a certain warming effect, resulting in a great difference between the assessed climate regulation value and the actual climate regulation value.

### SUMMARY

An objective of the present disclosure is to provide a method for evaluating a climate regulation value of vegetation, a product, a medium, and a device, thus improving the accuracy of the evaluation of a climate regulation value of vegetation.

To achieve the objective above, the present disclosure provides the following technical solution.

In a first aspect, the present disclosure provides a method for evaluating a climate regulation value of vegetation, including: obtaining surface net radiations and latent heat fluxes of the vegetation and bare land in a window staggered area by a window analysis method.

A difference of sensible heat fluxes of the vegetation and the bare land in the window staggered area is calculated according to the surface net radiations and the latent heat fluxes of the vegetation and the bare land in the window staggered area.

The climate regulation value of the vegetation is obtained by combining a replacement cost method of cooling by an air conditioner based on the difference between sensible heat fluxes of the vegetation and the bare land in the window staggered area.

In an embodiment, the obtaining surface net radiations and latent heat fluxes of the vegetation and bare land in a window staggered area by a window analysis method includes: reading tif files in a target area to obtain geographic position data of each tif file, and re-projecting the geographic position data to the same projection coordinate system; obtaining four boundaries with a largest range in all tif files to serve as an area to-be-divided, and dividing the area to-be-divided into grid areas with a size of 3×2 pixels; processing the grid areas using a window search method to acquire the window staggered area with both the vegetation and the bare land; and obtaining an average value of the surface net radiations of the vegetation, an average value of the latent heat fluxes of the vegetation, an average value of the surface net radiations of the bare land and an average value of the latent heat fluxes of the bare land in the window staggered area through window data statistics.

In an embodiment, the processing the grid area using a window search method to acquire the window staggered area with both the vegetation and bare land includes: creating a window with a size of 5×3 pixels, and traversing surface net radiation data and latent heat flux data of a vegetation area and surface net radiation data and latent heat flux data of a bare-land area with a step size of 3 pixels in an x direction and 2 pixels in a y direction; and extracting 5×3 pixel values from the window, and if there are the surface net radiation and the latent heat flux of the vegetation area and the surface net radiation and the latent heat flux of the bare-land area with pixel values greater than 0 in windows, determining the window as a staggered area.

In an embodiment, the calculating a difference between sensible heat fluxes of the vegetation and the bare land in the window staggered area according to the surface net radiations and the latent heat fluxes of the vegetation and the bare land in the window staggered area includes calculating the difference between sensible heat fluxes of the vegetation and the bare land in the window staggered area by using a grid computer tool of ArcGIS (Architecture Geographic Information System) through a surface energy balance equation.

In an embodiment, the calculating the difference between sensible heat fluxes of the vegetation and the bare land in the window staggered area includes: calculating a sensible heat flux H_{vege} of the vegetation area by a formula H_{vege}=Rn_{vege}−LE_{vege}, where Rn_{vege} is surface net radiation of the vegetation area, and LE_{vege} is a latent heat flux of the vegetation area; calculating a sensible heat flux H_{bare} of the bare-land area by a formula H_{bare}=Rn_{bare}−LE_{bare}, where Rn_{bare} is surface net radiation of the bare-land area, and LE_{bare} is a latent heat flux of the bare-land area; and calculating a difference ΔH between sensible heat fluxes of the vegetation and the bare land in the window staggered area by a formula ΔH=H_{vege}−H_{bare}.

In an embodiment, the obtaining the climate regulation value of the vegetation by combining a replacement cost method of cooling by an air conditioner based on the difference between sensible heat fluxes of the vegetation and the bare land in the window staggered area includes: calculating the number Nc of 1-horsepower (HP) air conditioners required for cooling per square meter by a formula Nc=ΔH÷RC based on the difference ΔH between the sensible heat fluxes of the vegetation and the bare land in the window staggered area, where RC is hourly heat absorption capacity of an 1-HP air conditioner when used for cooling; and calculating a climate regulation value V of the vegetation by a formula V=Nc×EC×P, where Ec is hourly power consumption of the 1-HP air conditioner, and P is electricity price.

In another aspect, the present disclosure further provides a computer program product, including a computer program. The computer program, when executed by a processor, is configured to implement the method for evaluating a climate regulation value of vegetation above.

In another aspect, the present disclosure further provides a computer readable storage medium. A computer program is stored on the computer readable storage medium, and the computer program, when executed by a processor, is configured to implement the method for evaluating a climate regulation value of vegetation above.

In still another aspect, the present disclosure further provides a memory, a processor, and a computer program stored on the memory and capable of being operated on the processor. The processor, when executing the computer program, is configured to implement the method for evaluating a climate regulation value of vegetation above.

According to specific embodiments of the present disclosure, the present disclosure has the following technical effects:

The surface net radiations and latent heat fluxes of vegetation and adjacent bare land within 5-km grid range are compared through a moving window analysis method, and a difference between sensible heat fluxes of the vegetation and the bare land is obtained by an energy difference method. A sensible heat flux can directly reflect the surface temperature, and has excellent characterization effect on the cooling effect of the vegetation. The difference between sensible heat fluxes of the vegetation and the bare land is used as an important index to quantify the climate regulation value, and then the difference between sensible heat fluxes is converted into the power consumption of an air conditioner to calculate the climate regulation value. According to the method, the problem of uncertain micro-climate volume of the temperature difference method is effectively avoided, the surface net radiation and the latent heat flux are introduced based on the transpiration method, thereby improving the existing method for evaluating a climate regulation value and an accuracy of a finally obtained vegetation climate regulation value.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a flow diagram of a method for evaluating a climate regulation value of vegetation according to the present disclosure;

FIG. 2 is a schematic diagram of a window analysis method adopted by the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure provides a method for evaluating a climate regulation value of vegetation, a product, a medium, and a device, thus improving the accuracy of the evaluation of a climate regulation value of vegetation.

In order to make the objectives, features and advantages of the present disclosure more clearly, the present disclosure is further described in detail below with reference to the accompanying drawings and specific embodiments.

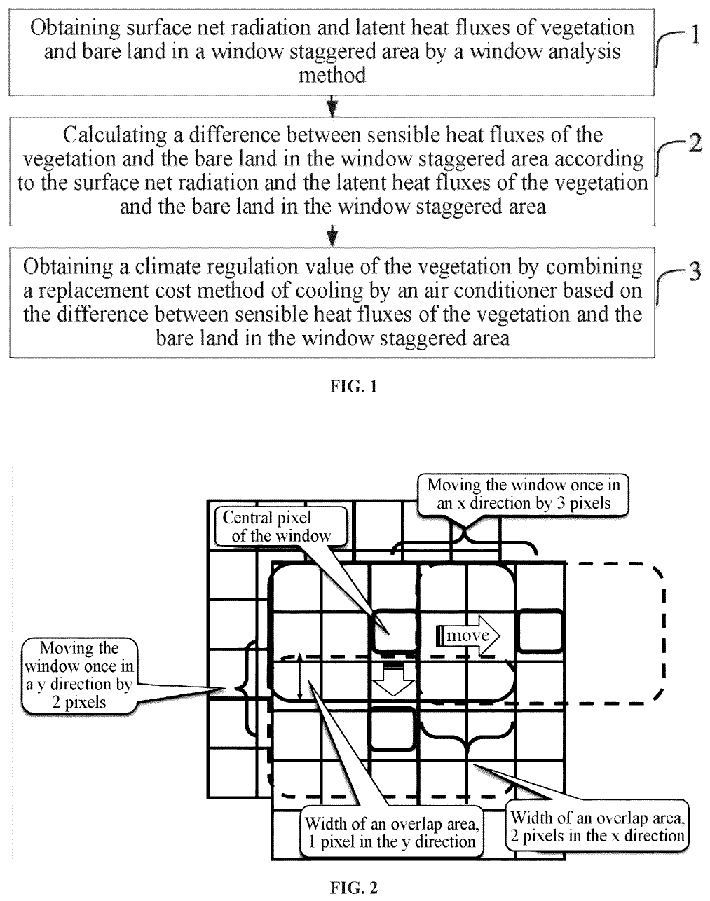

FIG. 1 is a flow diagram of a method for evaluating a climate regulation value of vegetation according to the present disclosure. Referring to FIG. 1, a method for evaluating a climate regulation value of vegetation according to the present disclosure includes the following steps:

Step 1. Surface net radiations and latent heat fluxes of the vegetation and bare land in a window staggered area are obtained by a window analysis method.

A moving window method is adopted by the present disclosure. Functions based on Python native library and a third-party library are used for processing to obtain average values of the surface net radiations and the latent heat fluxes of the vegetation and the bare land in the window staggered area, respectively. The specific steps are as follows:

Step 1.1. tif files in a target area are read to obtain geographic position data of each tif file, and the geographic position data is re-projected to the same projection coordinate system.

By combining the Python native library and the third-party library, each tif file in the target area is read as a two-dimensional matrix, and the geographic position data of tif is also read. The used Python native library and the third-party library may be rasterio, os, math, pickle, glob, numpy, shapefile, pyproj, tqdm, etc.

The tif file in the target area is acquired by a specific data collection device, which is a three-dimensional data file, the first dimension data of which is longitude information of a point on the earth, the second dimension data is latitude information of a point on the earth, and the third dimension data is a certain data value of this point, such as the surface net radiation, and the latent heat flux. The tif file is shown as a map file if opened with image software, and shown as a data file if opened with data processing software. The three-dimensional data of the tif file is read by the python software, including latitude and longitude, surface net radiation, and/or latent heat flux information. In Step 1.1, only two-dimensional matrix, i.e., the latitude and longitude information, needs to be read in the reading of the geographical location data, which is used to generate grids in space in Step 1. 2. The geographic position may be located in a vegetation area, or a bare-land area in the space.

The geographic location data is obtained by reading the tif file in the target area, the data with inconsistent projection coordinate systems need to be reprojected during data processing. The inconsistent geographic range needs to be considered during calculation, and windows are aligned by calculating the corresponding geographical position. A projection coordinate system of one of the data is used as a reference, and the projection coordinate systems of other data need to be consistent with the projection coordinate system of this data.

Step 1.2. four boundaries with a largest range in all tif files are obtained to serve as an area to-be-divided, and the area to-be-divided is divided into grid areas each with the size of 3×2 pixels.

All tif files are traversed and read to obtain four boundaries of all tif files in east, west, south and north directions, and the four boundaries with the largest range are used as the area to-be-divided. In the four boundary ranges of the area to-be-divided, with a tif pixel as the basis, four vertexes of each grid with the size of 3×2 pixels are calculated to generate a grid area.

Step 1.3. The grid areas are processed using a window search method to acquire the window staggered area with both the vegetation and the bare land.

As shown in FIG. 2, a window with a size of 5×3 pixels is created, and the window data is recorded in matrix form. The rows and columns of the matrix respectively represent the latitude and longitude information of a point on the earth, and a corresponding element value at a certain row and a certain column is surface net radiation data, or latent heat flux data at the latitude and longitude position. tif data of the surface net radiations and the latent heat fluxes in a vegetation area and a bare-land area (also known as a controlled area) are traversed by using the window with the size of 5×3 pixels, in the step size of window width-overlap width, which means that the step size in an x direction is 5−2=3 pixels, and the step size in a y direction is 3−1=2 pixels. 5×3 pixel values are read from the matrices with the size of 5×3 pixels of the surface net radiations and the latent heat fluxes of the vegetation area and the bare-land area by python, respectively. If there are the surface net radiation and the latent heat flux of the vegetation area and the surface net radiation and the latent heat flux of the controlled area with values greater than 0 in the 5×3 window, the window is determined as a staggered area.

Step 1.4. An average value of the surface net radiations of the vegetation, an average value of the latent heat fluxes of the vegetation, an average value of the surface net radiations of the bare land and an average value of the latent heat fluxes of the bare land in the window staggered area are obtained through window data statistics.

The classification into vegetation area and the controlled area are made in space according to land use data. The controlled area is bare land, and the surface net radiations and the latent heat fluxes of the vegetation area and the bare-land area are taken as target parameters. For the windows of the vegetation area and the bare-land area, an average value of target parameters=the sum of all pixel values greater than zero÷the number of pixel values greater than zero. For example, for 15 values in the 5×3 moving window, only three pixel values are greater than zero, the sum of all pixel values greater than zero is the sum of these three pixel values, the number of pixel values greater than zero is 3, and the average value of the target parameters is the sum divided by 3.

According to the number of rows and columns of the two-dimensional matrix (including the geographical location information of each tif file) read from the tif files of the surface net radiations and the latent heat fluxes in the vegetation area and the bare-land area in Step 1. 1, a new null matrix with the size of 3×2 pixels and all values of 0 is created to store average calculation results of the window staggered area in Step 1.4. An average value of the surface net radiation of the vegetation area in the window staggered area is recorded as Rn_{vege}, and an average value of the latent heat flux of the vegetation area in the window staggered area is recorded as LEᵥₑₙₑ. An average value of the surface net radiation of the bare-land area in the window staggered area is recorded as R_{bare}, and an average value of the latent heat flux of the bare-land area in the window staggered area is recorded as LE_{bare}.

Step 2. A difference between sensible heat fluxes of the vegetation and the bare land in the window staggered area is calculated according to the surface net radiations and the latent heat fluxes of the vegetation and the bare land in the window staggered area.

The difference between sensible heat fluxes of the vegetation and the bare land in the window staggered area is calculated by using a grid computer tool of ArcGIS through a surface energy balance equation. That is, the difference between the surface net radiation and the latent heat flux of the vegetation area and the difference between the surface net radiation and the latent heat fluxe of the bare-land area are calculated, respectively.

The surface net radiations and the latent heat fluxes are two main factors affecting the surface temperature and vegetation climate regulation. The sensible heat flux (H) is heat exchange between the atmosphere and the surface caused by temperature change, and the change of the sensible heat flux is manifested as the increase or decrease of surface temperature. According to the surface energy balance equation, the difference between sensible heat fluxes of the vegetation and the bare land is calculated by formulas (1)-(3).

H_{vege}=Rn_{vege}−LE_{vege} (1)

H_{bare}=Rn_{bare}−LE_{bare} (2)

ΔH=H_{vege}−H_{bare} (3)

H_{vege} is a sensible heat flux of the vegetation area, Rn_{vege} is a surface net radiation of the vegetation area, LE_{vege} is a latent heat flux of the vegetation area, H_{bare} is a sensible heat flux of the bare-land area, Rn_{bare} is a surface net radiation of the bare-land area, and LE_{bare} is a latent heat flux of the bare-land area; Rn_{vege}, LE_{vege}, Rn_{bare} and LE_{bare} are average values in the window staggered area, respectively; and ΔH is a difference between sensible heat fluxes of the vegetation and the bare land in the window staggered area, in the unit of MJ/m²/day.

Step 3. A climate regulation value of the vegetation is obtained by combining a replacement cost method of cooling by an air conditioner based on the difference between sensible heat fluxes of the vegetation and the bare land in the window staggered area.

The sensible heat flux can directly reflect the surface temperature, the energy difference between sensible heat fluxes of the vegetation and the bare land in the staggered area can characterize the climate regulation effect of the vegetation, i.e., temperature drop. By using the replacement cost method, an air conditioner with a certain refrigeration capacity is used to replace the heat absorption capacity of the vegetation, and the saved air conditioning electricity bill is used to replace the climate regulation value of the vegetation. The energy difference between sensible heat fluxes of the vegetation and the bare land in the staggered area is converted into power consumption of the air conditioner by formulas (4) and (5), thus obtaining the climate regulation value of the vegetation.

Nc=ΔH÷RC (4)

V=Nc×EC×P (5)

V is a climate regulation value (Yuan/m²/day) of the vegetation, Nc is the number of 1-HP air conditioners required for cooling per square meter, Ec is hourly power consumption (kWh) of the 1-HP air conditioner, P is electricity price (CNY/kWh), ΔH is a difference (MJ/m²/day) between sensible heat fluxes of the vegetation and the bare land, and RC is hourly heat absorption capacity (MJ/m²/day) of the 1-HP air conditioner when used for cooling. In some embodiments, RC=2.5 KW×3600/1000, EC-0.735 kWh, P=0.49 CNY/kWh.

According to the method for evaluating a climate regulation value of the vegetation provided by the present disclosure, the surface net radiations and the latent heat fluxes of the vegetation and the bare land within a 5-km grid range are obtained through the window analysis method, then the difference between sensible heat fluxes of the vegetation and the bare land in the staggered area is calculated, and subsequently, an evaluation value of the climate regulation value of the vegetation is obtained by combining a replacement cost method of cooling by the air conditioner, thus providing a scientific basis for the evaluation of the service value of the vegetation ecosystem, and achieving the technical effect of improving the climate regulation accuracy of the vegetation. The evaluation of the service value of the vegetation ecosystem includes water conservation, soil conservation, windbreak and sand fixation, climate regulation and other service functions, and the climate regulation value is a part of the service value. Different geographical locations have great differences in climate regulation. V greater than 0 indicates that the vegetation in the target area has a climate regulation function, and the greater the V, the higher the climate regulation value.

In some embodiments, the present disclosure further provides a computer program product, including a computer program. The computer program, when executed by a processor, is configured to implement the method for evaluating a climate regulation value of vegetation above.

In some embodiments, the present disclosure further provides a computer readable storage medium, where a computer program is stored on the computer readable storage medium, and the computer program, when executed by a processor, is configured to implement the method for evaluating a climate regulation value of vegetation above.

In some embodiments, the present disclosure further provides a computer device. The computer device includes a processor, a memory, an input/output interface (short for I/O), and a communication interface. The processor, the memory and the input/output are connected through a system bus, and the communication interface is connected to the system bus through the input/output interface. The processor of the computer device is used for providing computing and control capabilities. The memory of the computer device includes a non-transitory storage medium, and an internal memory. An operation system, a computer program and a database are stored in the non-transitory storage medium. The internal memory provides an environment for the running of the operation system and the computer program in the non-transitory storage medium. The database of the computer device is used for storing pending transactions. The input/output interface of the computer device is used for exchanging information between the processor and an external device. The communication interface of the computer device is used for communicating with an external terminal through a network. The computer program, when executed by a processor, is configured to implement the method for evaluating a climate regulation value of vegetation above.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A method for evaluating a climate regulation value of vegetation, comprising:
obtaining surface net radiations and latent heat fluxes of the vegetation and bare land in a window staggered area by a window analysis method;
calculating a difference between sensible heat fluxes of the vegetation and the bare land in the window staggered area according to the surface net radiations and the latent heat fluxes of the vegetation and the bare land in the window staggered area; and
obtaining the climate regulation value of the vegetation by combining a replacement cost method of cooling by an air conditioner based on the difference between sensible heat fluxes of the vegetation and the bare land in the window staggered area.

2. The method according to claim 1, wherein the obtaining surface net radiations and latent heat fluxes of the vegetation and bare land in a window staggered area by a window analysis method comprises:
reading tif files in a target area to obtain geographic position data of each tif file, and re-projecting the geographic position data to a same projection coordinate system;
obtaining four boundaries with a largest range in all tif files to serve as an area to-be-divided, and dividing the area to-be-divided into grid areas each with a size of 3×2 pixels;
processing the grid areas using a window search method to acquire the window staggered area with both the vegetation and the bare land; and
obtaining an average value of the surface net radiations of the vegetation, an average value of the latent heat fluxes of the vegetation, an average value of the surface net radiations of the bare land and an average value of the latent heat fluxes of the bare land in the window staggered area through window data statistics.

3. The method according to claim 2, wherein the processing the grid areas using a window search method to acquire the window staggered area with both the vegetation and bare land comprises:
creating a window with a size of 5×3 pixels, and traversing surface net radiation data and latent heat flux data of a vegetation area and surface net radiation data and latent heat flux data of a bare-land area with a step size of 3 pixels in an x direction and 2 pixels in a y direction; and
extracting 5×3 pixel values from the window, and when there are the surface net radiation and the latent heat flux of the vegetation area and the surface net radiation and the latent heat flux of the bare-land area with pixel values greater than 0 in windows, determining the window as a staggered area.

4. The method according to claim 2, wherein the calculating a difference between sensible heat fluxes of the vegetation and the bare land in the window staggered area according to the surface net radiations and the latent heat fluxes of the vegetation and the bare land in the window staggered area comprises:
calculating the difference between sensible heat fluxes of the vegetation and the bare land in the window staggered area by using a grid computer tool of ArcGIS (Architecture Geographic Information System) through a surface energy balance equation.

5. The method according to claim 4, wherein the calculating the difference between sensible heat fluxes of the vegetation and the bare land in the window staggered area comprises:
calculating a sensible heat flux H_{vege} of a vegetation area by a formula H_{vege}=Rn_{vege}−LE_{vege}, wherein Rn_{vege} is a surface net radiation of the vegetation area, and LE_{vege} is a latent heat flux of the vegetation area;
calculating a sensible heat flux H_{bare} of a bare-land area by a formula H_{bare}=Rn_{bare}−LE_{bare}, wherein Rn_{bare} is a surface net radiation of the bare-land area, and LE_{bare} is a latent heat flux of the bare-land area; and
calculating a difference ΔH between sensible heat fluxes of the vegetation and the bare land in the window staggered area by a formula ΔH=H_{vege}−H_{bare}.

6. The method according to claim 5, wherein the obtaining the climate regulation value of the vegetation by combining a replacement cost method of cooling by an air conditioner based on the difference between sensible heat fluxes of the vegetation and the bare land in the window staggered area comprises:
calculating a number Nc of 1-horsepower (HP) air conditioners required for cooling per square meter by a formula Nc=ΔH÷RC based on the difference ΔH between sensible heat fluxes of the vegetation and the bare land in the window staggered area, wherein RC is hourly heat absorption capacity of an 1-HP air conditioner when used for cooling; and
calculating a climate regulation value V of the vegetation by a formula V=Nc×EC×P, wherein Ec is hourly power consumption of the 1-HP air conditioner, and P is electricity price.

7. A non-transitory computer readable storage medium, wherein a computer program is stored on the computer readable storage medium, and the computer program, when executed by a processor, is configured to implement the method for evaluating a climate regulation value of vegetation according to claim 1.

8. The non-transitory computer readable storage medium according to claim 7, wherein the obtaining surface net radiations and latent heat fluxes of the vegetation and bare land in a window staggered area by a window analysis method comprises:
reading tif files in a target area to obtain geographic position data of each tif file, and re-projecting the geographic position data to a same projection coordinate system;
obtaining four boundaries with a largest range in all tif files to serve as an area to-be-divided, and dividing the area to-be-divided into grid areas each with a size of 3×2 pixels;
processing the grid areas using a window search method to acquire the window staggered area with both the vegetation and the bare land; and
obtaining an average value of the surface net radiations of the vegetation, an average value of the latent heat fluxes of the vegetation, an average value of the surface net radiations of the bare land and an average value of the latent heat fluxes of the bare land in the window staggered area through window data statistics.

9. The non-transitory computer readable storage medium according to claim 8, wherein the processing the grid areas using a window search method to acquire the window staggered area with both the vegetation and bare land comprises:
creating a window with a size of 5×3 pixels, and traversing surface net radiation data and latent heat flux data of a vegetation area and surface net radiation data and latent heat flux data of a bare-land area with a step size of 3 pixels in an x direction and 2 pixels in a y direction; and
extracting 5×3 pixel values from the window, and when there are the surface net radiation and the latent heat flux of the vegetation area and the surface net radiation and the latent heat flux of the bare-land area with pixel values greater than 0 in windows, determining the window as a staggered area.

10. The non-transitory computer readable storage medium according to claim 8, wherein the calculating a difference between sensible heat fluxes of the vegetation and the bare land in the window staggered area according to the surface net radiations and the latent heat fluxes of the vegetation and the bare land in the window staggered area comprises:
calculating the difference between sensible heat fluxes of the vegetation and the bare land in the window staggered area by using a grid computer tool of ArcGIS (Architecture Geographic Information System) through a surface energy balance equation.

11. The non-transitory computer readable storage medium according to claim 10, wherein the calculating the difference between sensible heat fluxes of the vegetation and the bare land in the window staggered area comprises:
calculating a sensible heat flux H_{vege} of a vegetation area by a formula H_{vege}=Rn_{vege}−LE_{vege}, wherein Rn_{vege} is a surface net radiation of the vegetation area, and LE_{vege} is a latent heat flux of the vegetation area;
calculating a sensible heat flux H_{bare} of a bare-land area by a formula H_{bare}=Rn_{bare}−LE_{bare}, wherein Rn_{bare} is a surface net radiation of the bare-land area, and LE_{bare} is a latent heat flux of the bare-land area; and
calculating a difference ΔH between sensible heat fluxes of the vegetation and the bare land in the window staggered area by a formula ΔH=H_{vege}−H_{bare}.

12. The non-transitory computer readable storage medium according to claim 11, wherein the obtaining the climate regulation value of the vegetation by combining a replacement cost method of cooling by an air conditioner based on the difference between sensible heat fluxes of the vegetation and the bare land in the window staggered area comprises:
calculating a number Nc of 1-horsepower (HP) air conditioners required for cooling per square meter by a formula Nc=ΔH÷RC based on the difference ΔH between sensible heat fluxes of the vegetation and the bare land in the window staggered area, wherein RC is hourly heat absorption capacity of an 1-HP air conditioner when used for cooling; and
calculating a climate regulation value V of the vegetation by a formula V=Nc×EC×P, wherein Ec is hourly power consumption of the 1-HP air conditioner, and P is electricity price.

13. A computer device, comprising: a memory, a processor, and a computer program stored on the memory and capable of being operated on the processor, wherein the processor, when executing the computer program, is configured to implement the method for evaluating a climate regulation value of vegetation according to claim 1.

14. The computer device according to claim 13, wherein the obtaining surface net radiations and latent heat fluxes of the vegetation and bare land in a window staggered area by a window analysis method comprises:
reading tif files in a target area to obtain geographic position data of each tif file, and re-projecting the geographic position data to a same projection coordinate system;
obtaining four boundaries with a largest range in all tif files to serve as an area to-be-divided, and dividing the area to-be-divided into grid areas each with a size of 3×2 pixels;
processing the grid areas using a window search method to acquire the window staggered area with both the vegetation and the bare land; and
obtaining an average value of the surface net radiations of the vegetation, an average value of the latent heat fluxes of the vegetation, an average value of the surface net radiations of the bare land and an average value of the latent heat fluxes of the bare land in the window staggered area through window data statistics.

15. The computer device according to claim 14, wherein the processing the grid areas using a window search method to acquire the window staggered area with both the vegetation and bare land comprises:
creating a window with a size of 5×3 pixels, and traversing surface net radiation data and latent heat flux data of a vegetation area and surface net radiation data and latent heat flux data of a bare-land area with a step size of 3 pixels in an x direction and 2 pixels in a y direction; and
extracting 5×3 pixel values from the window, and when there are the surface net radiation and the latent heat flux of the vegetation area and the surface net radiation and the latent heat flux of the bare-land area with pixel values greater than 0 in windows, determining the window as a staggered area.

16. The computer device according to claim 14, wherein the calculating a difference between sensible heat fluxes of the vegetation and the bare land in the window staggered area according to the surface net radiations and the latent heat fluxes of the vegetation and the bare land in the window staggered area comprises:
calculating the difference between sensible heat fluxes of the vegetation and the bare land in the window staggered area by using a grid computer tool of ArcGIS (Architecture Geographic Information System) through a surface energy balance equation.

17. The computer device according to claim 16, wherein the calculating the difference between sensible heat fluxes of the vegetation and the bare land in the window staggered area comprises:
calculating a sensible heat flux H_{vege} of a vegetation area by a formula H_{vege}=Rn_{vege}−LE_{vege}, wherein Rn_{vege} is a surface net radiation of the vegetation area, and LE_{vege} is a latent heat flux of the vegetation area;
calculating a sensible heat flux H_{bare} of a bare-land area by a formula H_{bare}=Rn_{bare}−LE_{bare}, wherein Rn_{bare} is a surface net radiation of the bare-land area, and LE_{bare} is a latent heat flux of the bare-land area; and
calculating a difference ΔH between sensible heat fluxes of the vegetation and the bare land in the window staggered area by a formula ΔH=H_{vege}−H_{bare}.

18. The computer device according to claim 17, wherein the obtaining the climate regulation value of the vegetation by combining a replacement cost method of cooling by an air conditioner based on the difference between sensible heat fluxes of the vegetation and the bare land in the window staggered area comprises:
calculating a number Nc of 1-horsepower (HP) air conditioners required for cooling per square meter by a formula Nc=ΔH÷RC based on the difference ΔH between sensible heat fluxes of the vegetation and the bare land in the window staggered area, wherein RC is hourly heat absorption capacity of an 1-HP air conditioner when used for cooling; and
calculating a climate regulation value V of the vegetation by a formula V=Nc×EC×P, wherein Ec is hourly power consumption of the 1-HP air conditioner, and P is electricity price.
